(19) United States
(12) Patent Application Publication
(10) Pub. No.: US 2016/0037591 A1
(43) Pub. Date: Feb. 4, 2016

(54) DESIGN AND METHODS TO PACKAGE AND INTERCONNECT HIGH INTENSITY LED DEVICES

(71) Applicants: Michael H. Brown, JR., River Falls, WI (US); Robert L. Sargent, Chelmsford, MA (US)

(72) Inventors: Michael H. Brown, JR., River Falls, WI (US); Robert L. Sargent, Chelmsford, MA (US)

(21) Appl. No.: 14/809,176

(22) Filed: Jul. 25, 2015

Related U.S. Application Data
(60) Provisional application No. 62/029,343, filed on Jul. 25, 2014.

(51) Int. Cl. H05B 33/06; H05B 33/10

(52) U.S. Cl. CPC H05B 33/06; H05B 33/10

(57) ABSTRACT

Design and methods to package and interconnect high intensity LED devices employ tabless LED devices adjoined in alternating polarities, such that an anode of one LED device is electrically connected to a cathode of an adjoining LED device to create a series. Electrical and positional connections are affected by connectors attached to the anode or cathode by means of fasteners, thermally conductive insulators optionally present.

### CROSS-REFERENCE TO RELATED APPLICATIONS

This application claims priority under 35 U.S.C. §119 (e) to, and hereby incorporates by reference, U.S. Provisional Application No. 62/029,343, filed 25 Jul. 2014.

### BACKGROUND OF THE INVENTION

1. Field of the Invention

This invention relates to printing with UV-sensitive inks and, in particular, this invention relates to devices emitting UV spectra to cure UV-sensitive inks.

2. Background

High intensity LED devices present great challenges in designing thermal energy management, optical energy management, and electrical energy management (interconnection). This is a particular problem in designing LED light-emitting systems that must focus high levels of specific wavelength light at relatively short distances, such as 10 mm-100 mm. These designs require high density packaging (mounting) of the LED devices.

### SUMMARY

This invention substantially meets the aforementioned needs of the industry by providing an LED assembly with improved thermal, energy, and electrical management methods and devices. The method and devices of this invention both mount the LED package and provide electrical connection as a highly desirable feature. Elimination of interconnecting wires and/or fasteners adds further to the reliability and simplicity of construction. Because of the high intensity light energy emitted, materials used must withstand the energy emitted at a particular wavelength of the applicable device or system.

Accordingly, there is provided an LED assembly comprising a plurality of electrically conductive connectors and a plurality of LED devices, each LED device including a cathode and an anode, the LED devices positioned side by side and such that the cathode of one LED device is electrically connected in series to the anode of an adjacent LED device by one of said conductive connectors.

There is further provided a method of manufacturing an LED assembly, comprising disposing a plurality of tabless LED devices such that adjacent LED devices are positionally alternating in polarities; and connecting an anode of one of said LED devices to an cathode of an adjacent LED device to establish an electrical series.

There is yet further provided a method of illuminating a substrate, comprising energizing a LED assembly, said LED assembly comprising a plurality of electrically conductive connectors; and a plurality of LED devices, each LED device including a LED, a cathode, and an anode, the LED devices positioned side by side and such that the cathode of one LED device is electrically connected in series to the anode of an adjacent LED device by one of said conductive connectors.

The assembled array of this invention may be designed with flat conductive surfaces allowing electrical connection and may be inherently reversible to allow a long string of such connections, thereby creating an array of these packages. In the case of LED assemblies, or devices, such an arrangement will create a repeating array of light-emitting sources.

The present invention uses standard circuit construction methods to create a layered package to mount one or more LEDs and provide external connections to the device.

The present device combines a mounting fastener and an electrical interconnection in one location.

The present invention utilizes a variable-length “dog bone” interconnecting straps to complete electrical circuit tree and allow for a variable “pitch” or spacing between LED devices.

“Dog bone” interconnects can be plated with gold or tin to eliminate or reduce corrosion and enhance electrical conductivity.

The present invention provides “daisy chaining” in an alternate polarity series circuit, by mounting the LED packages in an alternating polarity scheme.

The present invention utilizes “top hat” or “tube and ring” style insulators to create electrical isolation between devices.

The present invention provides high conductivity and “shortest path” of interconnection to minimize energy loss in the circuit.

The present invention provides ease of replacement, for example, using two screws (or other fasteners) per device to remove and replace.

Multiple screwed location options are possible by changing the base design and surface circuitry.

Secure mechanical connections are provided to enhance and maintain thermal conductivity to the mounting surface.

The devices and methods of this device for electrically interconnecting and positionally fixing LED devices may:
1. may be made of copper or other suitable electrically conductive material;
2. accommodate all densities of physical mounting;
3. withstand the high thermal and light energy environment produced by these devices;
4. utilize an alternate polarity mounting scheme to provide “series” connection of LED devices;
5. provide the ability to field-change individual LEDs;
6. provide “daisy chaining” in an alternate polarity series circuit by mounting the LED packages in an alternating polarity fashion; and
7. provide additional transfer of thermal energy away from the LED heat source.

Due to the ease of adding or eliminating modules, an assembly of a plurality of these LED devices is linearly scalable, in that intensity of radiation emitted (radiometric power) of the area(s) illuminated can be readily adjusted;

In one embodiment, the insulator is thermally conductive to enable more efficient and effective cooling of the device;

LED chips present on the device of this invention can be singly deployed or present in multiple arrays;

Thermal bolt holes may be combined with electrical anode(s)/cathode(s) on a single LED chip device for linear packaging; (the assembly method of this invention may be simplified as compared to connection methods of the prior art;

Dog-bone interconnects of differing sizes both dictate and influence linear radiometric power intensity in dosage;

Eliminate the need for longitudinally or peripherally extending electrical tabs, otherwise needed for electrical connection.

These and other features of this invention will become apparent from the description which follows, when considered in view of the accompanying drawings.

### BRIEF DESCRIPTION OF THE DRAWINGS

FIG. 1 is an exploded view of one embodiment of the LED device of this invention.

FIG. 2 is a perspective view of the LED device of FIG. 1.

FIG. 3 is a perspective view of a second embodiment of the LED device of this invention.

FIG. 4 is a perspective view of a third embodiment of the LED device of this invention.

FIG. 5 is a perspective view of a plurality of the embodiments of FIG. 1 connected in series.

FIG. 6 is a plan view of a plurality of LED devices electrically and positionally connected by the connectors of this invention.

FIG. 7 is a plan view of the plurality of LED devices depicted in FIG. 6 in which fasteners have secured the connectors in place.

FIG. 8 is a side view of one embodiment of the LED device of this invention secured electrically and positionally by the connector and fastener, with an insulated device deployed.

FIG. 9 is a plan view of one embodiment of the LED device of this invention.

It is understood that the above-described figures are only illustrative of the present invention and are not contemplated to limit the scope thereof.

### DETAILED DESCRIPTION

The materials, methods, and examples are illustrative only and not intended to be limiting. Comprehension of this invention can be gained through reference to the drawings in conjunction with a thorough review of the following explanation.

Each of the additional features and methods disclosed herein may be utilized separately or in conjunction with other features and methods to provide improved devices of this invention and methods for making and using the same. Representative examples of the teachings of the present invention, which examples utilize many of these additional features and methods in conjunction, will now be described in detail with reference to the drawings. This detailed description is merely intended to teach a person of skill in the art further details for practicing preferred aspects of the present teachings and is not intended to limit the scope of the invention. Therefore, the combinations of features and methods disclosed in the following detailed description may not be necessary to practice the invention in the broadest sense, and are instead taught merely to particularly describe representative and preferred embodiments of the invention. Consequently, a person of ordinary skill in the art will readily appreciate that individual components shown on various embodiments of the present invention are interchangeable to some extent and may be added or interchanged on other embodiments without departing from the spirit and scope of this invention.

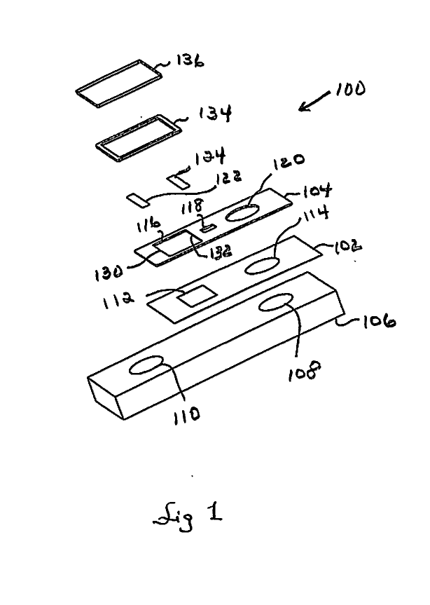

Referring to the figures, specifically FIG. 1, the tabless LED device of this invention, indicated at 100, includes a dielectric layer 102, disposed between a conductor 104 and a base 106. A mounting hole 108 and an electrical connection hole 110 are formed in the base 106. In the dielectric layer 102, openings such as a window 112 and electrical connect hole 114 may be present. Openings in the conductor may include a window 116, a slot 118, and electrical connect hole 120. A pair of pads 122, 124 may be present and, if present, may be positioned to align with margins 126, 128 of window 116, such that the pads 122, 124 are atop the conductor were such that the pads 122, 124 are disposed in the window 116 and abutting contact with margins 130, 132 of the conductor 104. A glass frame 134 may be present and positioned atop the pads 122, 124. A glass 136 may be positioned within the class frame 134 and secured in place therein. The mounting hole 108 and electrical connection hole 110 enable the base to be attached to a cooling device, such that the base contacts the cooling device to a maximum extent, thereby maximizing heat transfer from the LED device to the cooling device. The dielectric layer 102 may be selected from thermally conductive materials, as more fully described below. In one embodiment, an undepicted LED chip is operably positioned between the glass 136 and base 106.

Due to the placement of anode and cathode at interior positions, tabs for electrical connection are not present in the LED device of this invention. Consequently, the present tabless LED device can be placed in configurations utilizing less space than if one or more tabs extend from a LED device of the prior art. This space-saving feature of the LED device of this invention enables more LED devices to provide illumination from a smaller area than any known LED device of the prior art.

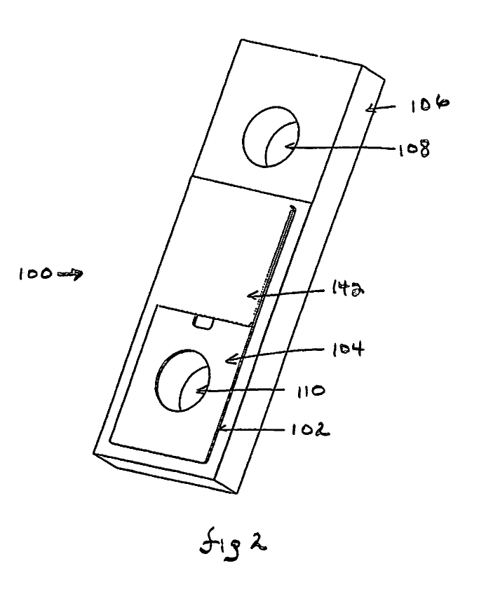

Referring to FIG. 2, the LED device of FIG. 1 is shown assembled, the pads 122, 124, glass frame 134, and glass 136 omitted from the figure. The omitted elements are designated at a site indicated by 142.

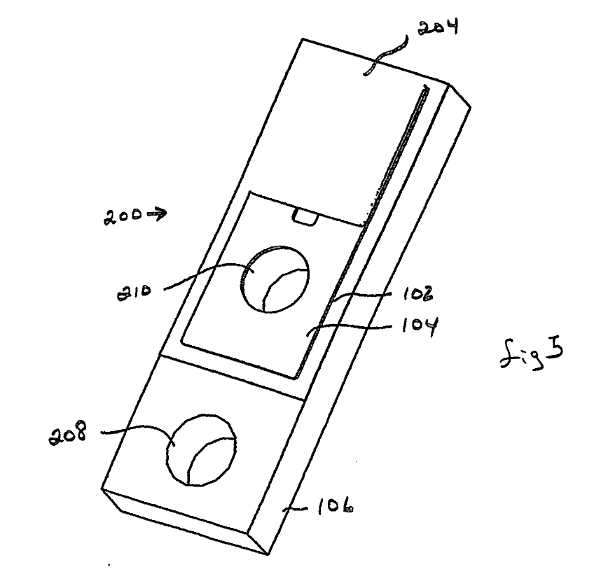

FIG. 3 depicts another embodiment of the LED device of this invention at 200, the pads 122, 124, glass frame 134, and glass 136 omitted from the figure. In the embodiment of FIG. 3, the LED, rather than being positioned generally at the center of the LED device as depicted in FIGS. 1, 2, is positioned proximate one end thereof, indicated at 204. The mounting hole 208 is at one longitudinal end and the electrical connector hole 210 is positioned in the center of the LED device 200.

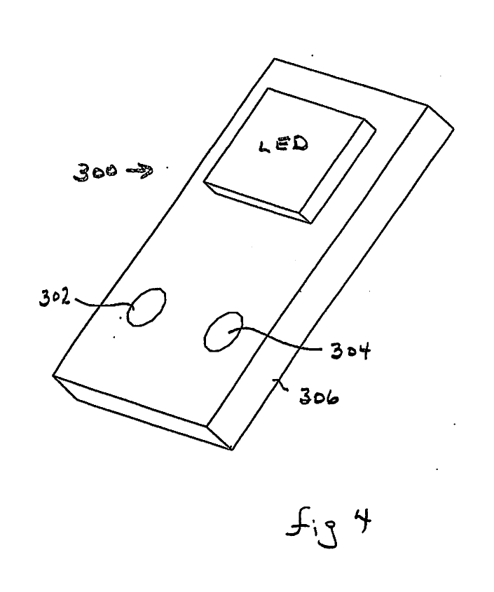

FIG. 4 shows yet another embodiment of the LED device of this invention generally at 300. The LED device 300 is depicted with an LED operably mounted at one longitudinal end thereof. In FIG. 4, the dielectric layer, electric conductive layer, pads, glass frame, and glass are not shown. However, holes 302, 304 are formed within the base 306. Either of the holes 302, 304 may be an electrical connect hole or a mounting hole, depending on where the dielectric layer, conductor, pads, glass frame, and glass are positioned.

Referring to FIG. 5, a plurality of, for example four, LED devices 100 are shown connected in series, the pads, glass frames, glass, and LED not being shown. However, in the case of FIGS. 2-5, a person of ordinary skill in the art will readily recognize that pads, glass frames, glass, and LEDs suitable for any anticipated uses can be selected. In FIG. 5, the LED devices 100 are electrically bonded in series by connectors 138 and fasteners 140. Thus, rather than being positioned in an array in which anodes and cathodes are identically oriented, the anodes and cathodes in the array shown in FIG. 5 are alternate, thereby allowing the series depicted.

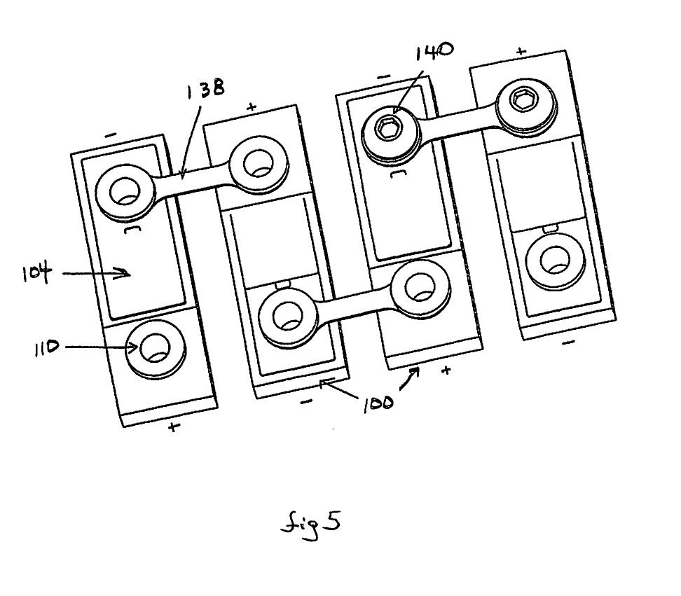

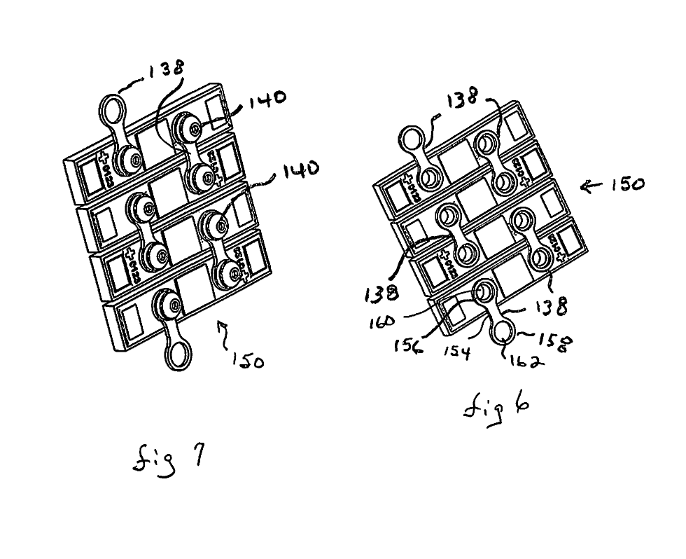

Referring to FIGS. 6, 7, additional detail is depicted in how the LED devices are electrically connected and positionally fixed by the connector and fasteners of the present invention. The LED assembly 150 includes a plurality of LED devices 100 in electrical connection by means of connectors 138 and fasteners 140. FIG. 6 shows the connectors 138 positioned in an anode of one LED device 100 and a cathode of an adjacent LED device 100. The connectors 138 are then secured in place by fasteners 140, such as mounting screws. The mounting screws may be inserted into predrilled holes in an underlying support, such as a surface of a cooling device.

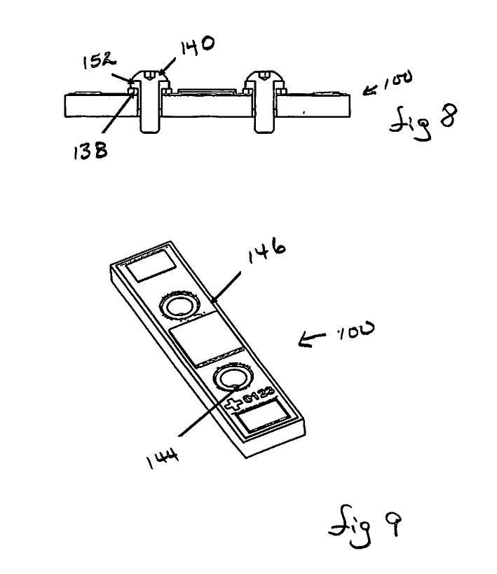

Referring to FIGS. 8, 9, respective positive and negative electrical connections 144, 146 are indicated on LED device 100. In FIG. 8 the connector 138 is secured in place and in electrical contact with one of the positive or negative electrical connectors 144, 146 by extending a fastener 140, such as a mounting screw, into an insulator 152.

The embodiment of the electrically connective connector 138 shown in FIG. 6 includes a conductive strip 154 with longitudinal lobes 156, 158, respective holes or openings 160, 162 formed in each of the lobes.

Suitable materials for the base 106 include copper (plated or unplated), gold, and alumina ceramic. Suitable materials for the dielectric layer 102 include polymer thick film die-electric, and Kapton (polyimide) film (DuPont). Suitable materials for the conductor 104 include copper, aluminum, and other conductors, such as copper alloys and plated copper. Suitable (dog bone) connectors to electrically connect the anodes to cathodes include copper and copper alloys (plated or un-plated) and other conductors known to persons of skill in the art. Suitable materials for the pads include gold (flash plated on copper) in other conductors known to persons of skill in the art.

Suitable LEDs would emit UV light spectra for curing UV-activated ink in the printing process in one embodiment. However, other LEDs would be suitable for other uses when the compact LED device of this invention is employed. Indeed, the LED device of this invention is advantageously used, for example, whenever conditions, such as limited space or volume, are present.

Present LED device enables a linear arrangement and infinitely definable light engine segments, thereby allowing irradiation to be controlled to a single LED device or an entire series with ease. The present LED device allows interchangeable segmentation to enable differential cooling and interchangeability and ease of segments replacement. The LED device of this invention, when deployed as an array depicted herein, combines thermal bolt holes with electrical anode/cathode, large single LED chip device for linear packaging. The present LED device in array of this invention may incorporate thermally conductive insulators for heat transfer. Variable-sized dog-bone connects dictate/influence linear radiometric power intensity in dosage. Simple assembly method of the LED array of this invention removes cumbersome additional steps to assembly thereof, thereby allowing easy end-user replacement for simple tools.

Because numerous modifications of this invention may be made without departing from the spirit thereof, the scope of the invention is not to be limited to the embodiments illustrated and described. Rather, the scope of the invention is to be determined by the appended claims and their equivalents.

What is claimed is:

1. An LED assembly, comprising:
a plurality of electrically conductive connectors; and
a plurality of LED devices, each LED device including a LED, a cathode and an anode, the LED devices positioned side by side and such that the cathode of one LED device is electrically connected in series to the anode of an adjacent LED device by one of said conductive connectors.

2. The LED assembly of claim 1, wherein, each of said LED devices comprises a dielectric layer disposed between a conductor and a base.

3. The LED assembly of claim 2, wherein mounting and electrical connection holes are formed in said base.

4. The LED assembly of claim 2, wherein an electrical connect hole and a window are formed in said dielectric layer.

5. The LED assembly of claim 2, wherein a window is defined in said conductor.

6. The LED assembly of claim 1, wherein each said conductive connector is secured in place by a fastener.

7. The LED assembly of claim 6, wherein each said fastener is secured within an insulator.

8. The LED assembly of claim 7, wherein each said insulator is thermally conductive.

9. The LED assembly of claim 1, wherein one of said LEDs is generally centrally located on one of said LED devices.

10. The LED assembly of claim 1, wherein one of said LEDs is disposed proximate a longitudinal end of one of said LED devices.

11. A method of manufacturing an LED assembly, comprising:
disposing a plurality of tabless LED devices such that adjacent, LED devices are positionally alternating in polarities; and
connecting an anode of one of said LED devices to a cathode of an adjacent LED device to establish an electrical series.

12. The method of claim 11, wherein said cathode of one of said LED devices is connected to said anode of said adjacent LED device by an electrically conductive connector.

13. The method of claim 12, wherein said connector includes a conductive strip and lobes longitudinally disposed with respect to said conductive strip.

14. The method of claim 13, wherein a fastener is disposed in a hole formed in each said lobe.

15. The method of claim 14, wherein an insulator is disposed in each said hole.

16. The method of claim 15, wherein, said insulator is thermally conductive.

17. A method of illuminating a substrate, comprising energizing a LED assembly, said LED assembly comprising a plurality of electrically conductive connectors; and a plurality of LED devices, each LED device including a LED, a cathode, and an anode, the LED devices positioned side by side and such that the cathode of one LED device is electrically connected in series to the anode of an adjacent LED device by one of said conductive connectors.

18. The method of claim 17, wherein each of said conductive connectors is a lobed conductive strip having a hole in each longitudinally disposed lobe.

19. The method of claim 18, wherein each a fastener is affixed into each said hole.

20. The method of claim 19, wherein each said fastener is disposed within an insulator.
